(19) United States
(12) Patent Application Publication
(10) Pub. No.: US 2009/0315272 A1
(43) Pub. Date: Dec. 24, 2009

(54) BRUSH SEAL DEVICE

(75) Inventors: Hidetoshi Kasahara, Tokyo (JP); Toru Kono, Tokyo (JP)

Correspondence Address: ARENT FOX LLP, 1050 CONNECTICUT AVENUE, N.W., SUITE 400, WASHINGTON, DC, 20036, US

(73) Assignee: EAGLE INDUSTRY CO., LTD., TOKYO (JP)

(21) Appl. No.: 12/307,455

(22) PCT Filed: Jul. 4, 2007
(86) PCT No.: PCT/JP2007/063385

§ 371 Date: Jan. 5, 2009

(30) Foreign Application Priority Data
Jul. 6, 2006 (JP) 2006-187080

(51) Int. Cl. F16J 15/44

(52) U.S. Cl. 277/355

(57) ABSTRACT

A divided brush seal comprises a base portion to shut off a sealing fluid side area and environment area, a first end portion having a first connecting face at one side divided end of the base portion, a second end portion having a second connecting face at another divided end of the base portion which connects with the first end portion, a seal brush having bristle groups to seal the sealing fluid provided parallel to a supporting face with coupling one end thereof to a fixed portion which connects with the base plate, wherein the first end portion and the second end portion comprise a first bristle groups respectively, a wire diameter of a first bristle of the first bristle groups is thicker with respect to a wire diameter of a second bristle of a second bristle groups provided between the first bristle group of the first end portion and the first bristle group of the second end portion, the first bristle group of the respective divided brush seal and the first bristle group of the other side divided brush seal adjacent thereto are sequentially arranged.

### FIELD OF THE INVENTION

This invention relates to a brush seal device to seal between a fixed component and a relative moving component of assembling portion of an engine or a power generation gas turbine engine. More particularly, the present invention relates to a brush seal device to prevent the abrasion of a seal brush by a sealing fluid which acts between connecting spaces of a divided portion in a brush seal device which tightly connects the divided portion.

### BACKGROUND OF THE INVENTION

For example, when a ring shape brush seal device is assembled between bearings of a steam turbine, it is necessary to remove a rotary body and the bearings to assemble the brush seal device. In addition, when the rotary body has a large diameter, a brush seal device will have larger diameter in response to that, thus a yield rate deteriorates because the brush seal device is cut out from the material including the dimension of this large diameter. Further, since the large size brush seal device is heavy weight articles, it is necessary to assemble by hanging using a crane and the like which would be difficult to assemble. Thus, it is considered to assemble by dividing the brush seal device. However, when a pressure of the sealing fluid acts to the divided portion of the brush seal device, it has been identified that performance of the brush seal device is reduced.

This problem will be further described. As for a brush seal device according to the present invention, a brush seal comprised of bristles have an identical wire diameter, there is a brush seal device wherein various brush seal aligned in an axial direction as a multilayer. FIG. 10 is a cross sectional view showing one side of a brush seal device 100 relating to the present invention which is mounted between a rotor 120 and a barrel 110. For example, the brush seal device 100 relates to FIG. 4 of Patent Document 1 described in a following mentioned paragraph 0009, or FIG. 4 of Patent Document 2 described in the following mentioned paragraph 0009. A purpose of the invention of the brush seal 100 is different from a purpose of the present invention. Namely, this brush seal device 100 is aimed to be removable against the barrel 110. However, in the brush alignment of the brush seal device 100, there are points which are similar to the present invention. Therefore, it will be specified as a prior art of the present invention.

In FIG. 10, a rotor 120 and a barrel 110 shown for mounting the brush seal device 100 are parts of a turbine. The brush seal device 100 is arranged between the rotor 120 and a cylindrical barrel 110 arranged at an outer circumference of the rotor 120. Then, the sealing fluid in a first gap E which is present between the rotor 120 and the barrel 110 is shut out by the brush seal device 100 as the first gap E of the sealing fluid side and a second gap O of an outer side. A plurality of ring shape knife edge 110A which project out to an inner diameter side is provided at the outer side gap O of the brush seal device 100. These knife edges 110A, 110A seal the sealing fluid as a labyrinth seal.

The brush seal device 100 is mounted to an end portion of the barrel 110 via a retainer 111. Also, a sealing bristle 101 which are a bundle of the fine wires, and a packing bristle 102 which are a bundle of the thick wires are arranged in parallel between a packing plate 105 of the first gap E side at the sealing fluid side and a packing plate 106 of the second gap O side of the outer side.

An inner diameter dimension of an inner circumference face 101A of the seal bristle 101, an inner circumference face 102A of the packing bristle 102, and an inner circumference face 106A of the packing plate 106 are formed so that it becomes larger sequentially towards the second gap O side of the outer side (right side of the drawing). Then, it is constituted that the seal bristle 101 is supported by the packing bristle 102, and the packing bristle 102 is supported by the packing plate 106 against a pressure of the sealing fluid.

When the brush seal device 100 constituted as such receives the pressure of the sealing fluid, since the seal bristle 101 is formed as the most longest from a fixed end to the inner diameter, and a side face of the seal bristle is contacted and supported by the packing bristle 102 of the thick wires as well as the seal bristle 101 is the most fine wires, the free end side rubs against the packing bristle 102 while fluctuates continuously. Therefore, it is a problem that the seal bristle 101 which are fine wires to abrade the first, thus reduce the sealing ability. In particular, when receiving the pressure change of the sealing fluid, the seal bristle 101 which directly contacts with the sealing fluid, and tends to promote the abrasion by getting the seal bristle 101 into the packing bristle 102.

Next, as an another similar invention, there is a brush seal which has improved the abrasion of the inner circumferential contact face and the chamfering of the inner circumferential surface of the brush seal device which rises when rotary axis is eccentric. Although the illustration thereof is omitted, there is a brush seal wherein the arrangement of the bristles (layer) are reversed to each other which is the opposite of the above mentioned brush seal device. This prior art is disclosed in FIG. 3 and FIG. 4 of Patent Document 3 which is mentioned in a following paragraph 0009. Namely, there is a brush seal that a packing bristle (layer) having thick wire diameter is arranged at a side of the sealing fluid side gap and a sealing bristle (layer) having narrow wire diameter which is arranged at a gap side of outer portion side. However, in this brush seal device, when receiving a sealing fluid pressure, the whole sealing ability decreases rapidly, because a free end side of the seal bristle which is narrow wire material ware outs rapidly and the sealing fluid leaks from the ware out portion.

Patent Document 1: U.S. Pat. No. 5,630,590 (Japanese translation laid open No. 2000-508732)

Patent Document 2: U.S. Pat. No. 5,201,530

Patent Document 3: U.S. Pat. No. 5,335,920

### DISCLOSURE OF THE INVENTION

### Problems to be Solved by the Invention

The present invention is made by considering such problems. And a problem to be solved by the present invention is to prevent the abrasion of each brush wire members neighboring to a connecting portion due to the scuffing together with the outer force such as a fluid pressure, a vibration force and the like. Further, it aims to improve the sealing ability of the connecting portion of a brush seal device. Furthermore, it aims to reduce the manufacturing cost by making the production of a brush seal device easy which is composed of a large number of bristle.

### Means for Solving the Problem

The present invention has been made to solve the above technical problems. Accordingly, a technical solving means is composed as follows.

A brush seal device according to the present invention is a brush seal device having a divided brush seal equipped to one component of a stationary component and a relative moving component to shut off a space between the stationary and the relative moving components, said divided brush seal comprising;

a base having a mounting body section available to be held on the one component and having a support face located at a side face of sealing fluid side extending from the mounting body section to another component side,

a first end portion having a first connecting face at one connecting end side of the base,

a second end portion having a second connecting face at another connecting end face, and

a seal brush having bristle groups arranged as a plate shape along with the supporting face from the first end portion to the second end portion, wherein;

said bristle groups includes bristles extending parallel to said supporting face, free ends of said bristles are facing to another component, base ends of said bristles are fixed with a fasting portion on said mounting body section,

said bristle groups are composed of a first bristle group of the first end portion with a first length range, another first bristle group of the second end portion with a second length range, and a second bristle group provided between the first bristle groups of the first length range and the second length range,

wire diameters of the first bristles are thicker than those of the second bristles,

said first connecting face of the first end portion of one divided brush seal and said second connecting face of the second end portion of another divided brush seal are connectable, and

the first connecting face of the first bristle group included in the first end portion of one divided brush seal and the second connecting face of the first bristle group included in the second end portion of another divided brush seal are connectable each other.

### EFFECTS OF THE INVENTION

A brush seal device according to the present invention, a first end portion of a first divided brush seal and a second end portion of a second divided brush seal are connected sequentially to form a brush seal device. In this connecting portion of the divided brush seal, a fine gap is formed between a first and a second connecting faces opposing to each other, upon considering a thermal deformation by the heat of sealing fluid and an allowance for assembling the divided brush seal. Thus, when receiving a pressure of the sealing fluid, the seal brush adjacent to the gap oscillates as swinging. However, since a wire diameter of a first bristle of a first bristle group is formed thicker than a wire diameter of a second bristle of a second bristle group, the first bristle group do not oscillate and the abrasion thereof is prevented. Therefore, during long term operation, since the first bristle group and the second bristle group abrade almost equally, it effectively prevents the sealing fluid leak from the gap between the first and the second connecting faces due to a quick abrasion of the first bristle group at the connecting portion.

Also, manufacturing cost of this brush seal device can be reduced as the manufacturing is easy, since the first bristle group and the second bristle group can be aligned in a range which is set by dividing. Further, it is available to realize the sealing performance by the second bristle group which is a large part of the seal brush. Furthermore, the abrasion of the seal brush raised by an outer force at a connecting portion of the divided brush seal can be prevented effectively by the first bristle group as well as the sealing performance can be exerted.

### BRIEF EXPLANATION OF DRAWINGS

FIG. 1 is a front view of a divided brush seal according to a first embodiment of the present invention.

FIG. 2 is a front view of an inner circumferential side of a connecting portion of the other divided brush seal which connects with the divided brush seal in FIG. 1.

FIG. 3 is a front view of a main section of the connecting portion of a brush seal device according to a second embodiment of the present invention viewing from a side view.

FIG. 4 is a cross sectional view showing the brush seal device according to the first embodiment of the present embodiment mounted between a stationary component and a relative moving component.

FIG. 5 is a perspective view of a first end portion of the divided brush seal in FIG. 1.

FIG. 6 is a perspective view of a second end portion of the divided brush seal in FIG. 1.

FIG. 7 is a front view near a line A-A of the divided brush seal in FIG. 1.

FIG. 8 is a cross sectional view of a brush seal device according to a third embodiment of the present invention.

FIG. 9 is a side view near a boundary section of the first bristle layer and the second bristle layer in FIG. 1.

FIG. 10 is an one side partial cross sectional view showing the mounting status of a brush seal device in a prior art with respect to the present invention.

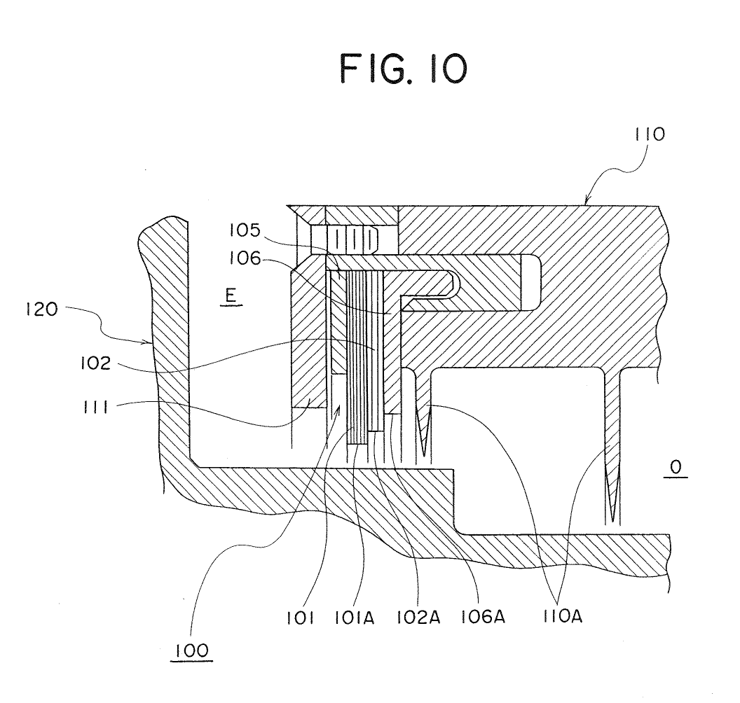

### EXPLANATION OF NUMERAL REFERENCES

1 Brush Seal Device
2 Divided Brush Seal
3 Base
3A Supporting Plate
3A1 Supporting Face
3A2 First Inner Circumferential Face
3A3 First Seal Plate Portion
3B Holding Plate
3B1 Gapped Lower Face
3B2 Second Circumferential Face
3B3 Second Seal Plate Portion
3B5 Engagement Groove
3C Mounting Body Section
3X First End Portion
3Y Second End Portion
4A First Connecting Face
4A1 First Radial Direction Face
4A2 Second Circumferential Face
4A3 Third Radial Face (First Connecting Face In Case Of Gap Portion)
4B Second Connecting Face
4B1 First Radial Direction Face
4B2 Second Circumferential Direction Face
4B3 Third Radial Face (Second Connecting Face In Case Of Gap Portion)
6 Mounting Space Portion
6A Sandwiching Portion
9 Plate Spring
10 Seal Brush
11 Bristle Group (Bristle Layer)
11A First Bristle Group (First Bristle Layer)
11A1 First Bristle
11B Second Bristle Group (Second Bristle Layer)
11B1 Second Bristle
12 Seal Portion
12A Inner Circumferential Face
13 Fastening Portion
L1 First Length Range
L2 Second Length Range
L3 Third Length Range
D Space
P Sealing Fluid Pressure
R Connecting Portion

### BEST MODE FOR CARRYING THE INVENTION

Here, the brush seal device of embodiments according to the present invention will be specified with reference to the drawings. Note that, following described drawings are based on the design drawings.

### First Embodiment

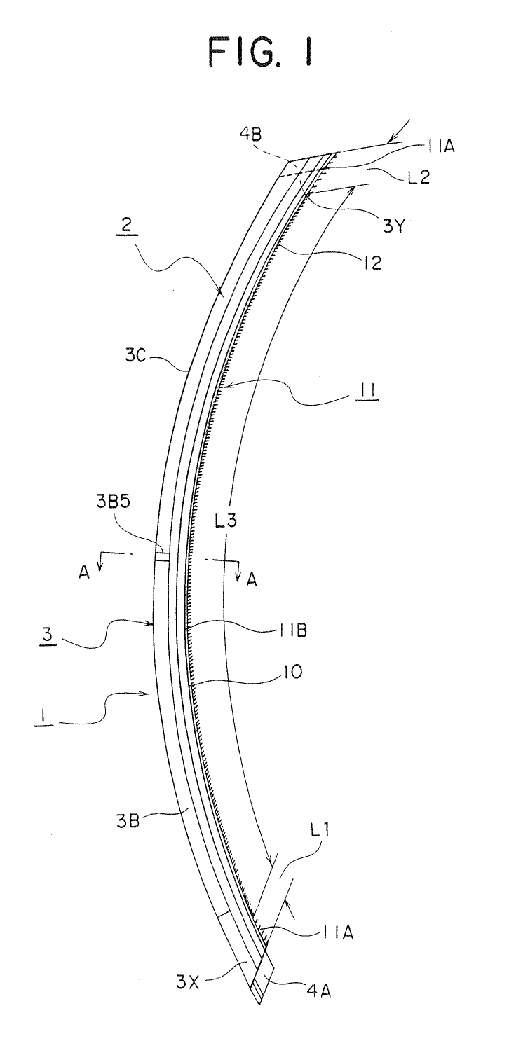

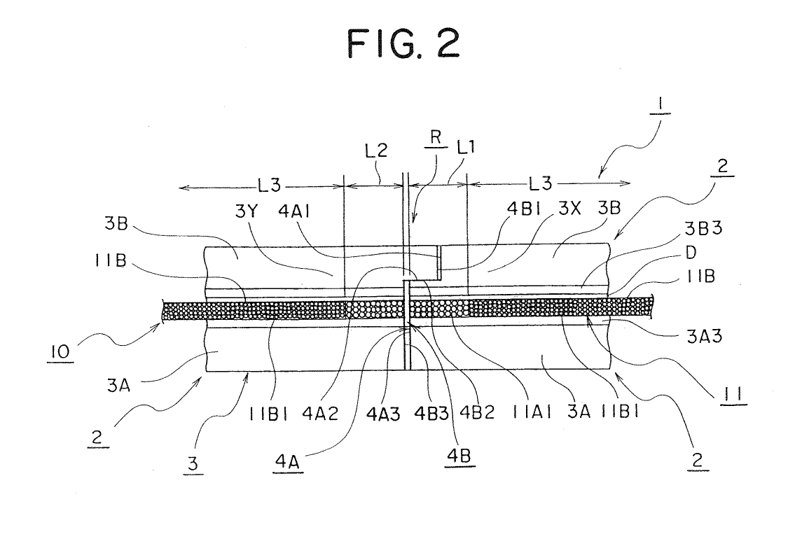

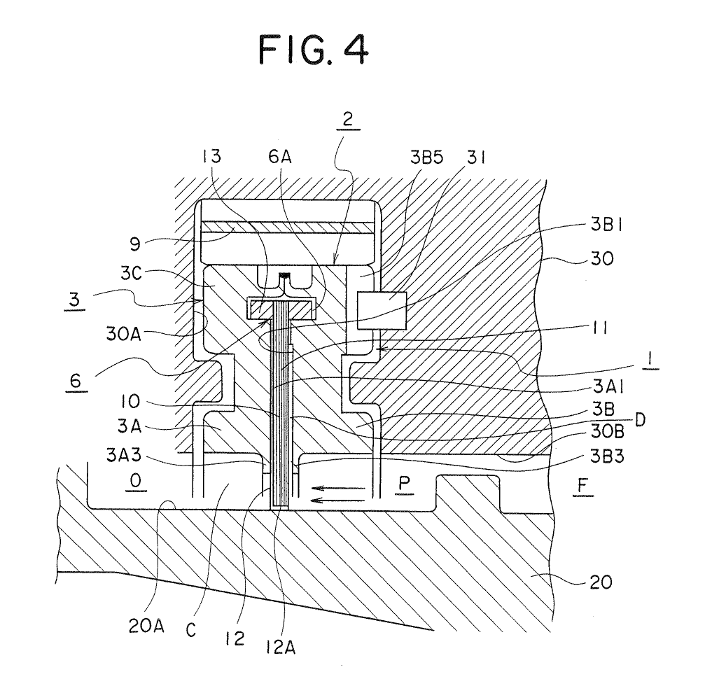

This brush seal device seals, for example, the leaking of the high temperature and high pressure fluid, or cooling air from a gap between a stationary component and a rotary component. A brush seal of a preferred embodiment according to the present invention will be described. FIG. 1 shows one of divided brush seals 2 divided from a brush seal device 1. FIG. 2 is a front view viewing from an inner circumferential side of a connecting portion R of the two divided brush seals 2, 2 in the brush seal device 1. FIG. 4 is a cross sectional view along a line A-A of FIG. 1 when the brush seal device 1 is mounted to assembly components. This brush seal device 1 is formed in a ring shape by connecting first and second end portions 3X, 3Y of the divided brush seals 2. And, for example, in order to seal a gap C between the components of a turbine engine as shown in FIG. 4, the brush seal device 1 is equipped.

A rotor assembly 20 of the assembly components in the turbine engine is held by a bearing which is not shown. Also, a barrel 30 is formed in a cylindrical shape and is fit concentrically by providing an annular gap C between an inner circumferential face 30B with respect to the outer circumferential face 20A of the rotor assembly. For preventing the leakage of the sealing fluid from the gap C of the sealing fluid side F to an outer side O, as shown in FIG. 4, a brush seal device 1 is provided at a mounting portion 30A of the barrel 30 or a mounting portion of the rotor assembly 20 (corresponding to 30A of FIG. 4) to cut off the gap C. The mounting portion 30A is formed as a groove shape to compose a ring shape which is available to attach the brush seal 1. A pin 31 is inserted and fixed in a hole provided at equal interval along the side circumferential face of the mounting portion 30A.

The brush seal device 1 is formed as a ring shape by connecting respective divided brush seal 2, respective first end portion 3X and a second end portion 3Y of respective connecting side which are divided as circular arc shape from a ring shaped body. Although the structure of the barrel 30 is complicated, the divided brush seal 2 can be attached with the mounting portion 30A by sequentially connecting the respective first and the second end portion 3X, 3Y of the divided seal 2, it may be fitted while assembling towards a circumferential direction from the outer circumferential side to the outer circumferential face 20A without disassembling the rotor assembly 20, and the yield of the material is increased because the base portion 3 and the fastening portion 13 can be cut out respectively from the material having a size of the divided brush seal 2, in case that the conventional base portion 3 has a ring shape with large diameter.

Also, as shown in FIG. 4, in the divided brush seal 2, a supporting plate (also called as supporting portion) 3A formed as an ring shape and a holding plate (also called as holding portion) 3B formed as a ring shape are connected facing to each other, an outer circumferential side of this connecting portion is integrated by welding and the like to the base portion 3. This base portion 3 is formed at a mounting body section 3C to which the outer circumferential side is mounted to the mounting portion 30A. In the supporting plate 3A and the holding plate 3B, a free end side of the mounting body section 3C is formed on the seal plate portion by providing a first seal plate portion 3A3 and a second seal plate portion 3B3 respectively at the inner radial direction extending to an inner radial side in a flange shape. The seal plate portion shuts off a large part of the gap C. The outer shapes of the supporting plate 3A and the holding plate 3B are formed in substantially symmetrical shape except for the engagement groove 3B5 and a lower face with gap 3B1 of the supporting plate 3. Note that, the engagement groove 3B5 provided on an outer side face of the holding plate 3B which constitutes the mounting body section 3C causes the brush seal device 1 pivotally inoperative by engaging the pin 31, and makes the divided brush seal 2 easy to mount after positioning. Further, when the fastening portion 13 is mountable to the supporting plate 3A only, the supporting plate 3A becomes the base portion 3. Then, the mounting portion 30A is formed on the supporting plate 3A.

A mounting space portion 6 having T-shape cross section and formed in the hyperbolic length, is formed between the supporting plate 3A and the holding plate 3B. An outer circumferential side of the mounting space portion 6 is formed at a sandwiching portion 6A. Also, an inner circumferential face in radial direction at the mounting space 6 side of the supporting portion 3A is formed at a supporting face 3A1. Also, the inner circumferential face in a radial direction at the mounting space portion 6 side (sealing fluid side) of the holding portion 3B is formed at a space D in which a space between the supporting face 3A1 becomes larger than a width size of the sandwiching portion 6A side by forming an inner circumferential side of the face, which opposes to the supporting face 3A1 on a gapped lower face 3B1. Even if the seal brush 10 is mounted to the enlarged space D as shown in FIG. 4, the sealing fluid can flow in between the seal brush 10 and the gapped lower face 3B1 from the sealing fluid side F.

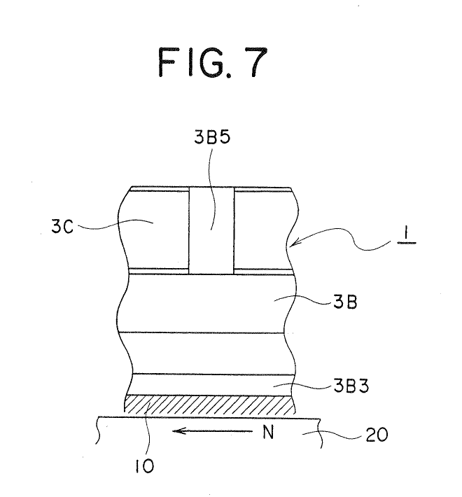

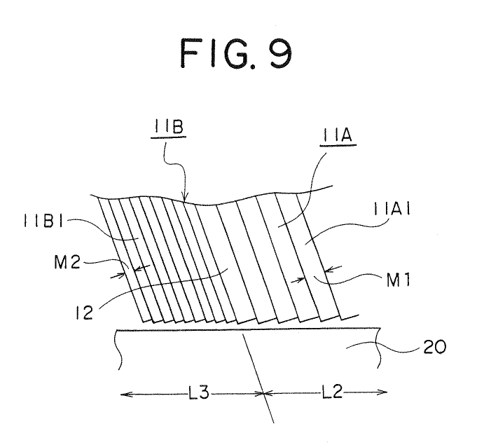

As shown in FIG. 4, in the mounting space portion 6, the bristles 11A1 and 11B1 (also refer to FIG. 9) composed of large number of steel wires which are thickened to a thickness for sealing the sealing fluid to an axial direction, as well as a bristle group (hereinafter referred to “bristle layer”) 11 formed in a plate shape by arraying towards a circumferential direction with this thickness, and a fastening portion 13 having a rectangular cross sectional face connecting an outer circumferential end portion of the bristle layer 11 are provided to the seal brush 10 which is mounted on the mounting space portion 6. It is preferable that the arrangement of the bristle 11A1, 11B1 are inclined to a rotational direction as shown in FIG. 7. An inner circumferential side (also referred as “free end”) of the bristle layer 11 of the seal brush 10 is formed on a sealing portion 12 having small diameter projecting towards the inner direction with respect to an inner radius of both the first seal plate portion 3A3 and the second seal plate portion 3B3. This inner circumferential face 12A of the sealing portion 12 formed as a size having a slight connection with an outer circumferential side 20A of a rotor assembly 20, or having a slight space.

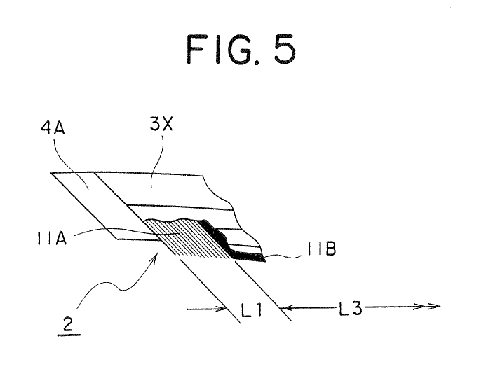

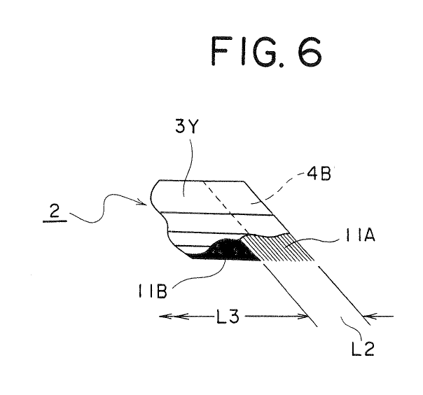

Following are described by referring to FIG. 2, FIG. 4, FIG. 5, FIG. 6 and FIG. 9. FIG. 5 is an enlarged figure of a first end portion 3X which is the lower side of FIG. 1. Also, FIG. 6 is an enlarged figure of a second end portion 3Y which is an upper side of FIG. 1. Further, FIG. 9 is an enlarged side view of one part of the seal portion 12 near the boundary of the respective first bristle group (hereinafter referred as “first bristle layer”) 11A and the second bristle group (hereinafter referred as “second bristle layer”) 11B of FIG. 1. Then, as shown in FIG. 5, a first length range L1 of the first bristle layer 11A of the first end portion 3X side at the bristle layer 11 of the divided brush seal 2 (a length from a connecting face of the first bristle layer 11A (also referred as “first connecting face”) to the second bristle layer 11B) and, as shown in FIG. 6, a second length range L2 of the first bristle layer 11A of the second end portion 3Y side (a length from a connecting face of the first bristle layer 11A (referred as “second connecting face”) to the second bristle layer 11B) forms the first bristle layer 11A by aligning the first bristle 11A1 having thicker diameter M1 than the diameter M2 of the second bristle 11B1 aligned at the third length range L3 which is between the first length range L1 and the second length range L3 of the divided brush seal.

Also, it is preferable that the first length range L1 of one of the first bristle layer 11A and the second length range L2 of the other first bristle layer 11A are set in a range of 7 mm to 25 mm from the connecting face of the respective first bristle layer 11A in the divided brush seal 2 to the second bristle layer 11B side. More preferably, the length range L1, L2 of the first bristle layers 11A and 11A respectively are set in a range of 10 mm to 20 mm. Further, a ratio of a total length of the first length range L1 of one of the first bristle layer 11A+the second length range L2 of the other first bristle layer 11A in an entire circumference with respect to the entire circumference of the seal brush 10 is preferably less than 10%. As for the reason of this, when the total ratio in the entire circumference of the first length range L1 of the respective first bristle layer 11A+the length of the second length range L2+ . . . to the length ranges L3+L3+ . . . of the circumferential direction of the entire second bristle layers 11B is set to more than 10%, there is a risk to accelerate the abrasion of the seal brush 10 and the rotor assembly (rotation member) 20 when sliding, because the rigidity of the seal brush 10 becomes too high. Further, it is noted when the first length range L1 of the first bristle layer 11A+the second length range L2 of the first bristle layer 11A is less than 7 mm, the sealing ability is deteriorated because the abrasion of the second bristle layer 11B of the first bristle layer 11A side is accelerated. Note that, it is preferable that the first length range L1 and the second length range L2 are substantially the same length. Also, as shown in FIG. 1, in case that a connecting portion R which a first connecting face 4A and a second connecting face 4B are connected with a gap, it is preferable that a total length of the first length range L1 and the second length range L2 is longer than the length of a first circumferential direction face 4A2 and 4B2.

In FIG. 9, it is preferable that the diameter M1 of the first bristle 11A1 of the first bristle layer 11A is 1.15 to 1.90 times thicker than the diameter M2 of the second bristle 11B1 of the second bristle layer 11B. Further, a ratio of the diameter M1 of the first bristle 11A1 to the diameter M2 of the second bristle 11B1 is preferably 1.20 to 1.70 times. If the above mentioned magnification is less than 1.15 times, then the wearing ratio of the diameter M1 of the first bristle 11A1 increases when receiving the fluctuating pressure of the sealing fluid. On the contrary, if the above mentioned magnification is larger than 1.90 times, it is noted that the sealing capability is reduced since the whole rigidity becomes higher. Note that, in case that a ratio of the diameter M1 of the first bristle 11A1 to the diameter M2 of the second bristle 11B1 is 1.3 times, the rigidity of the first bristle 11A1 becomes about 2.9 times compared to the rigidity of the second bristle 11B1. As stated above, if the thickness of a wire diameter of the first bristle 11A1 at the connecting portion R of the respective divided brush seal portion 2 is in the range of 1.15 times to 1.90 times thicker than the thickness of the second bristle 11B1, it is noted from the experiment that the abrasion of the first bristle 11A1 can be prevented and the sealing ability can be exerted during a long period by the second bristle layer 11B. Namely, even if the bristle layer 11 is worn out during a long period, it is noted that it is possible to prevent the leakage of the sealing fluid from one part at the early stage, as well as the sealing capability of the brush seal device 1 is increased, since the first bristle layer 11A and the second bristle layer 11B wear out equally.

As shown in FIG. 2, a first connecting face (also referred as “first opposed face”) 4A with gap is formed at the first end portion 3X of the connecting side of the base portion 3 of the divided brush seal 2, and a second connecting face 4B with gap is formed at the second end portion 3Y. Also, the first connecting face 4A and the second connecting face (also referred as “second opposed face”) 4B may be inclined towards the circumferential direction. The first connecting face 4A and the second connecting face 4B are formed in a symmetric shape so as to be able to connect by placing a space to each other. Then, the first connecting face 4A of the first divided brush seal 2 and the second connecting face 4B of a second divided brush seal 2 are connected by facing each other, as well as the first connecting face 4A of the second divided brush seal 2 and the second connecting face 4B of a third divided brush seal 2 having the same shape are connected by facing each other. This first connecting face 4A is formed from, among the first connecting face 4A, two first radial direction face 4A1 and a second radial direction face (the first connecting face) 4A3, and one first circumferential direction face 4A2. Also, the second connecting face 4B is formed from, among the connecting face 4B, two first radial direction face 4B1 and a second radial direction face (the second connecting face) 4B3 and one first circumferential face 4B2. Note that, as the other embodiments, the first connecting face 4A with gap and the second connecting face 4B with gap do not have gaps, but divided towards an axial direction (radially divided); or divided to an axial direction with inclined to a circumferential direction. In case that connecting faces different from this embodiment 1, the bristle layer 11 is constituted as similar to the above mentioned embodiment 1. Also, the first connecting face of the first bristle layer 11A at the first end portion 3X and the second connecting face of the first bristle layer 11A at the second end portion 3Y may be joined.

Then, the connecting portion R of the first connecting face 4A and the second connecting face 4B connects the second circumferential direction face 4A2 of the first connecting face 4A and the second circumferential direction face 4B2 of the second connecting face 4B; and the respective radial direction faces 4A1 and 4A3 of the first connecting face 4A and the respective radial direction faces 4B1 and 4B3 of the second connecting face 4B are connected by small space considering the deformation and the like. In this manner, each connecting portion R of a third and a fourth brush seals 2 are connected sequentially to form a ring shape. Note that, the first, the second . . . divided brush seals 2, 2 are referred as sequential number which connect annularly. Further, a joint portion of the first connecting face 4A and the second connecting face 4B is referred as a joint portion R.

### Second Embodiment

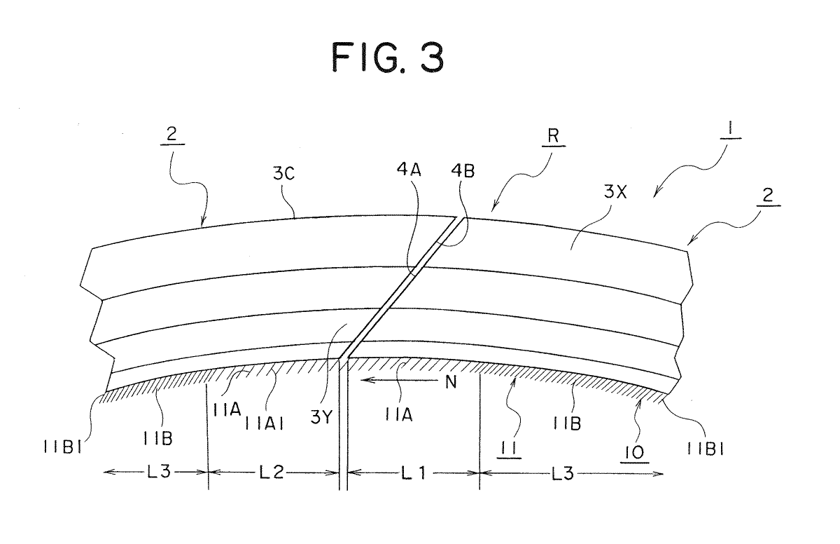

FIG. 3 is a cross sectional view showing a connecting portion R of a brush seal device 1 of a second embodiment according to the present invention. This connecting portion R of a first connecting face 4A and a second connecting face 4B is divided towards an axial direction inclined towards a circumferential direction of the brush seal device 1. Note that, in this connecting portion R, the a first length range L1 of a first bristle layer 11A of a first end portion 3X and a second length range L2 of a first bristle layer 11A of a second end portion 3Y may be formed within a range of 7 mm to 25 mm from the inner circumferential end faces of a first connecting face (end face) of the first bristle layer 11A of the first connecting face 4A side and a second connecting face (end face) of the first bristle layer 11A of the second connecting face 4B side to an inner circumferential direction of a second bristle layer 11B, respectively. More preferably, the first length range L1 and the second length range L2 are 10 mm to 20 mm. Also, a rotational direction of a rotary member is to the N-direction. Other constitutions are almost identical to the symbols as shown.

FIG. 7 is a front view of the engagement groove 3B5 in a mounting body section 3C (a front view of arrow A-A of FIG. 1). As sown in FIG. 4, the mounting body section 3C of a brush seal device 1 is equipped to a mounting portion 30A provided on a barrel 30 after connecting to the divided brush seals 2, or while connecting the divided brush seals 2. The brush seal device 1 is mounted by inserting the engagement groove 3B5 of the divided brush seal portion 2 to a pin 31 provided while the barrel 30 pressing towards an inner circumference side by snapping a plate spring 9 equipped on an outer circumferential side of the mounting body section 3C in the mounting portion 30A. Then, the brush seal device 1 is engaged towards the circumferential direction by the pin 31. Thus, the brush seal device 1 can be mounted extremely easily. However, a gap is produced between the first connecting face 4A and the second connecting face 4B of the connecting portion R due to the assembling. Then, although when the sealing fluid leaks from this gap, the seal brush tends to wear out due to the flactuation, the abrasion of the second bristle layer 11B as well as the first bristle layer 11A can be prevented by the respective first bristle layers 11A provided at the connecting portion R.

### Third Embodiment

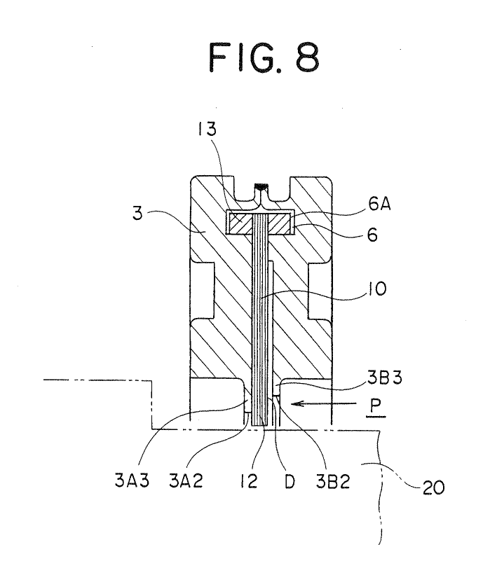

FIG. 8 is a cross sectional view of a brush seal device 1 of a third embodiment according to the present invention. In FIG. 8, a different point from FIG. 4 is that it is possible to make an inner radial face 3A2 of a first seal plate 3A3 of a supporting plate 3A close to an outer circumferential face 20A of a rotor assembly 20 by making the inner radial face 3A2 of the first seal plate portion 3A3 of the supporting plate 3A smaller than an inner radial face 3B2 of a second seal plate 3B3 of a holding plate 3B. By this first seal plate portion 3A3, a seal portion 12 of a seal brush 10 can be supported strongly against a pressure of the sealing fluid. As a result of this, swinging of the seal brush 10 due to the fluctuating pressure of the sealing fluid can be prevented. Also, when a second bristle layer 11B tries to contact with a rotation member, it effectively prevents the wearing of a contact portion by the elastic deformation in response to a force of the tip side while supported by the first seal plate 3A3. Note that, although the first seal plate 3A3 is made so that a thickness of an inner radial side of a plate 3A is made thinner towards an axial direction as shown in FIG. 8, the thickness of the supporting plate 3A towards the axial direction may be made substantially the same.

In case of the brush seal device 1 composed as above, when the sealing fluid leaks from the connecting gap between the first contact face 4A and the second connecting face 4B at the connecting portion R of the divided brush seal 2, in case of a conventional bristle, the bristles adjacent to the connecting portion R abrade at the end, as a result of the friction against each other. However, the first bristle 11A equipped at the connecting portion R of the present invention, since it is made thicker than the second bristle 11B1, the rigidity of the first bristle 11A1 becomes multiple times (about 2.9 times) compared to that of the second bristle 11B1. Therefore, the first bristle layer 11A composed of the first bristle 11A1 can be prevented from rubbing each other even when receiving the pressure P of the sealing fluid. As a result of this, the sealing ability of the brush seal device 1 is improved since the abrasion is prevented even when the seal brush 10 receives the flow of the pressure fluid or the fluctuating pressure.

Also, when the high temperature sealing fluid flows in a passage of a passage tube in a gas turbine and the like, in some case the high temperature sealing fluid leaks out from the contact face of the respective passage. Also, on the contrary to this, in some cases the sealing fluid for cooling the passage tube may flow in from the contact face. Thermal efficiency of the gas turbine is lowered, if these sealing fluids leak from the contact faces. Further, if the sealing fluid leaks from the contact faces, a temperature of the gas in the passage tube become locally high and, the passage components such as turbine blades and the stator vanes in a downstream of the passage becomes high temperature. Duration of the components is decreased which is made of materials without considering this matter. Even in such various cases, by attaching the brush seal device 1 of the present invention between the respective contact faces of the passage tube, it is possible to effectively seal the sealing fluid leaking from the respective contact face. Simultaneously, the abrasion of the first bristle layer 11A and the second bristle layer 11B at the connecting portion R can be effectively prevented.

Other than the above embodiments, as a usage of the present invention, it can be used to the fixed components and the relative movement components which move relatively in linear or in a curving fashion. For example, in the nuclear plant components or the industrial machines and the like, the cross section of the fixed component is formed in a square or a circular shape and formed as a linear rail or an annular rail. On the other hand, the relative movement components are devices which move while surrounding the rails. The pressure fluid acts to an inner portion of the rail side of the device corresponding to the relative movement component. In this case, in the present invention, it is constituted that the divided brush seal device 1 is mounted to the relative movement component and the seal brush 10 side of the brush seal device 1 faces to the fixed component. Then, when the relative movement component moves relatively on the rail which is the fixed component, the sealing fluid present in the internal of the device is sealed by the brush seal device 1.

In the following, with respect to the other embodiments of the brush seal device according to the present invention, constitution, functions and effects thereof will be described.

A brush seal device of a first invention of an embodiment according to the present invention in which a relative moving component is a rotation component, respective divided brush seal is formed as a circular arc, a first connecting face of a first end portion and a second connecting face of a second end portion are arranged as adjacent to each other, a first contact face of a first bristle group of the first end portion and a second connecting face of a first bristle group of the second end portion are connected with each other by contacting so as to form the divided brush seal around the rotation component in a ring shape.

In a brush seal device of a first invention according to the present invention, in case that a base portion has larger diameter, it is necessary to cut out the base portion from a large material which meets the large base portion, however since it is possible to cut out a material meeting the divided base portion as the circumference has been divided, the yield of the material improves. Also, although a gap between both of the connecting faces of the connecting portion of the annular brush seal device varies due to the expansion and contraction by the temperature or the assembling matters, the sealing ability of the connecting portion in the brush seal device is improved by the both first bristle groups which are each connected by contacting with each other even when the gap becomes larger. Also, the abrasion of the seal brush can be prevented by the first bristle group composed of thick bristles. Further, it has a similar effect described in the above mentioned paragraph of the present invention.

A brush seal device of a second invention according to the present invention has a wire diameter of the first bristle of each first bristle layer is from 1.2 times to 1.7 times thicker than a wire diameter of a second bristle of a second bristle layer.

In the brush seal device of the second invention according to the present invention, since a wire diameter of each first group bristle layer is made from 1.2 times to 1.7 times thicker than a wire diameter of a second bristle of a second bristle layer, the abrasion of the first bristle group at the connecting portion of the divided brush seal is prevented, and the same level of the durability as the second bristle group is confirmed. Accordingly, it becomes possible to perform sealing ability of the second bristle group dramatically.

A brush seal device of a third invention according to the present invention is formed so that a first length range and a second length range of each first bristle group are within the range 10 mm or more and 20 mm or less from an inner diameter ends of a first connecting face and a second connecting face.

In the brush seal device of the third invention according to the present invention, since the length of the respective bristle group is formed in 10 mm to 20 mm length, at the connecting portion of the divided brush seal, when the sealing fluid leaks from a contact gap of the first connecting face and the second connecting face towards a lower pressure side, each first bristle having rigidity is not swinging by a pressure of the sealing fluid, thus, it is available to prevent the abrasion. Also, since the length of the first bristle group is shorter than the length of the second bristle group, effect of the sealing ability can be performed by the second bristle group without inhibiting the sealing ability of the second bristle group.

### INDUSTRIAL APPLICABILITY

As mentioned above, the brush seal of the present invention is useful to be used between the mounting faces of each assembling component of a general apparatus which seals the fluctuating pressure fluid and the high pressure fluid. Particularly, it is useful as a brush seal device used between the mounting faces with a thermal stress or the vibrating mounting faces due to the high temperature and the high pressure fluid of a steam turbine, a gas turbine or a nuclear plant component and the like. Further, in a connecting portion of a divided brush seal, by making a single layer seal brush possible, it is useful as a brush seal device which can reduce the manufacturing cost.

1. A brush seal device having a divided brush seal equipped to one component of a stationary component and a relative moving component to shut off a space between the stationary and the relative moving components, said divided brush seal comprising;
a base having a mounting body section available to be held on the one component and having a support face located at a side face of sealing fluid side extending from the mounting body section to another component side,
a first end portion having a first connecting face at one connecting end side of the base,
a second end portion having a second connecting face at another connecting end face, and
a seal brush having bristle groups arranged as a plate shape along with the supporting face from the first end portion to the second end portion, wherein;
said bristle groups includes bristles extending parallel to said supporting face, free ends of said bristles are facing to another component, base ends of said bristles are fixed with a fasting portion held on said mounting body section,
said bristle groups are composed of a first bristle group of the first end portion with a first length range, another first bristle group of the second end portion with a second length range, and a second bristle group provided between the first bristle groups of the first length range and the second length range,
wire diameters of the first bristles are thicker than those of the second bristles,
said first connecting face of the first end portion of one divided brush seal and said second connecting face of the second end portion of another divided brush seal are connectable, and
the first connecting face of the first bristle group included in the first end portion of one divided brush seal and the second connecting face of the first bristle group included in the second end portion of another divided brush seal are connectable each other.

2. The brush seal device as set forth in claim 1, wherein;
said relative moving component is a rotary component, said respective divided brush seals are formed as arcuate,
said first connecting face of said first end portion of one divided brush seal and said second connecting face of said second end portion of another divided brush seal are arranged adjacent each other, and
the divided brush seals are arranged as ring shape around said rotary component by connecting the first connecting face of said first bristle group of said first end portion of the one divided brush seal and said second connecting face of said first bristle group of said second end portion of another brush seal with contacting each other.

3. The brush seal device as set forth in claims 1 or 2, wherein;
the wire diameters of said first bristles of said respective first bristle group is formed as 1.2 to 1.7 times with respect to the wire diameter of said second bristles of said second bristle group.

4. The brush seal device as set forth in claims 1 or 2, wherein;
said respective first bristle groups are formed so that the first length range and the second length range from inner diameter ends of said first connecting face and said second connecting face are within a range from 10 mm to 20 mm.
